(19) United States
(12) Patent Application Publication
(10) Pub. No.: US 2010/0310131 A1
(43) Pub. Date: Dec. 9, 2010

(54) METHOD FOR DETERMINING A QUALITY STANDARD FOR A PRODUCT PROCESSED BY A PROCESSING MACHINE

(76) Inventors: David SCHMITT, Lohr Am Main (DE); Holger Schnabel, Veitschoechheim (DE); Hans-Juergen Doeres, Frammersbach (DE); Michael Seubert, Retzstadt (DE); Stephan Schultze, Lohr-Wombach (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/795,090

(22) Filed: Jun. 7, 2010

(30) Foreign Application Priority Data
Jun. 5, 2009 (DE) 10 2009 023 963.4

(51) Int. Cl. G06K 9/00

(52) U.S. Cl. 382/112

(57) ABSTRACT

The invention relates to a method for determining a quality standard for a product processed by a processing machine, in particular a printing press, having at least two printing units, in which the processing positions of the at least two printing units relative to one another are determined, and based on the determined processing positions, the quality standard is ascertained.

### CROSS-REFERENCE TO RELATED APPLICATION

This application is based on German Patent Application 10 2009 023 963.4 filed Jun. 5, 2009.

### BACKGROUND OF THE INVENTION

1. Field of the Invention

The invention relates to a method for determining a quality standard for a product processed by a processing machine, in particular a printing press.

Although reference will be made below primarily to printing presses, the invention is not limited to them but instead is directed to all kinds of processing machines in which material in the form of a web of material, or in the form of single sheets, is processed. However, the invention can be used particularly in printing presses, such as newspaper printing presses, job printing presses, intaglio presses, packaging printing presses, or banknote printing presses, as well as in such processing machines as bag making machines, envelope making machines, or packaging machines. The material may be paper, fabric, cardboard, plastic, metal, or rubber, and may be in the form of film or foil, etc.

2. Description of the Prior Art

In printing presses, such as intaglio presses, a longitudinal register and a lateral register are typically regulated in order to achieve an optimal outcome of printing. One possibility for register regulation is based on printed marks applied by the printing units. To identify its own processing position, each printing unit prints at least one processing mark, in the form of a register mark, on the material being processed (web or sheet). In addition, sensors in the form of register mark sensors that detect the applicable mark on the material are disposed downstream of the individual printing units. It is also known to use a camera-based sensor at the end of the printing press, for detecting all the printed marks. In a controller, a longitudinal and/or lateral register deviation is determined from the position of the marks detected, and a correction is made as needed.

Besides register regulation, quality monitoring is also used in some cases. To that end, there is a special sensor, typically downstream of the last printing unit in the press or downstream of the last processing station, with the aid of which measurement data for determining the quality of the product are ascertained. This sensor is typically a camera-based system. As quality data, usually color information (such as color saturation) is ascertained; optionally, register information can also be ascertained.

In European patent disclosure EP 1 167 036 A1, for example, a system for determining quality by means of a CCD camera is described. EP 1 894 728 A1 describes a quality monitoring system for inkjet print heads by means of a high-resolution camera.

In EP 0 884 178 B1, a camera-based system is described that ascertains not only the quality data but register errors as well. Especially with long web lengths between the printing unit and the sensor, this has not inconsiderable disadvantages in regulation because of the down times that occur, or in other words the time difference between the printing operation and the measurement operation.

The camera-based versions known in the prior art are very expensive. Moreover, they have the grave disadvantage that not every product can be measured, for lack of sufficient computing power.

There is accordingly a need for an economical, yet usable, method for determining a quality standard.

### ADVANTAGES AND SUMMARY OF THE INVENTION

According to the invention, a method for determining a quality standard for a product processed by a processing machine, in particular a printing press, having at least two processing devices, in particular printing devices or printing units, is proposed.

The invention is based on the one hand on the recognition that a quality standard that is conclusive for numerous purposes can be obtained solely by measuring the individual partial products that make up the (end) product. Even if determining the color saturation is dispensed with, it is possible solely by determining the processing positions, preferably of all the processing devices, by means of at least one detection unit to determine a standard indicating the quality or quality standard that is adequate for many kinds of uses, since often all that is needed is a simplified form of quality monitoring. On the other hand, the invention is based on the recognition that at least one mark sensor intended for the register regulation can also be used for determining the quality of the processed product. Thus the additional cameras used in the prior art for determining quality can be dispensed with. This reduces the procurement and operating costs of the processing machine substantially. Both principles offer the option of measuring all the end products and thus being able for instance to provide a more-conclusive standard for the average quality. If a mark sensor is used, the partial products can advantageously be assessed by determining the longitudinal and/or lateral register.

Expediently, the processing positions of the at least two processing devices relative to one another are determined by means of determining errors in the longitudinal and/or lateral register. This form of quality analysis is thus based on detecting the longitudinal register error of the lateral register error. Because in a further feature precisely one sensor ascertains all the register errors in a product, the evaluation is simplified considerably.

Advantageously, the processing positions of the at least two processing devices relative to one another are determined downstream of the last processing device in the material flow direction. At the end of the processing operation, such as a printing operation, the product is available as the sum of all the processing steps, such as printing a partial image. Thus at this point, the quality of the product can be determined especially simply. For this purpose, the sensor that is present anyway for regulating the longitudinal register and the lateral register of the last processing device is preferably used. Then that sensor is used not only for measuring the longitudinal and/or lateral register error of the last processing device but simultaneously for measuring the processing positions, such as the longitudinal and/or lateral register, of all the other processing devices as well.

In one feature, for identifying its own processing position, at least one processing mark each is applied to a material being processed by the at least two processing devices, and the processing positions of the at least two processing devices are determined by detecting at least one processing mark each. A processing position, such as the longitudinal and/or lateral register, can be determined especially simply by scanning processing marks, such as register marks. A detection unit embodied as a mark sensor, that is, as an intensity sensor, is especially well suited for this purpose. Different colors do not have to be resolved.

It is advantageous if the quality standard is determined for each processed product. Optionally, the data on each product can be stored in memory, to make it possible to provide quality documentation if needed.

Expediently, the quality standard is stored in memory in compressed or uncompressed form. There are various possibilities for doing so. On the one hand, one maximum value per product (such as a printing format or printed sheet) can be formed. In the above example pertaining to the measurement of longitudinal and lateral register errors, two measured values for register error are obtained per product and per printing color (=partial image). This data set is reduced by forming a maximum value for all the register error values of one product (optionally separated into the longitudinal and lateral directions). What can be obtained then is only one (or two) values per product. On the other hand, evaluation can be done in accordance with limit values. If the ascertained maximum values are additionally categorized by limit values, then a further reduction in the data per product is attained (to the point of a single binary datum). Statistical evaluation is also contemplated. For instance, if the measured values compared with limit values are merely counted (for example by the number of good vs. bad products), further data compression is achieved. In that case, however, the data can no longer be associated with individual products; instead, only a total statement of the quality of the production generated can be made.

Linking the quality standard to the basic product also offers advantages. For instance, if quality data stored product by product are put into relation with the entire production, the ensuing further processing of the products can evaluate these data. Thus individual products of lesser quality, for instance, can be filtered out automatically (for instance by ejecting a sheet) before further processing. The linkage can be done by data storage independently of the product, data storage for the entire set of products (such as RFID data storage media on a palette), or data storage on each individual product (for instance by separate marking which marks the defective product, the marking being applied for instance by laser to the web of material in the printing press).

Evaluating a number of quality standards is also expedient. This can be done by comparison of quality data from different production runs. If a drop in quality is found, it can serve as a sign to take corrective steps (maintenance). For example, it may be necessary to clean pressure rollers, replace motor bearings, and the like. Regular evaluation of the quality data during production is also expedient. For example, if an average rejection rate increases markedly over a short period of observation during a production run (such as limit value comparison of the mean value of register errors per 100 produced products), this can also be used as an impetus for checking production-relevant variables. For instance, the amount of water supplied or the set web tension can be corrected. Evaluating the quality data with regard to the machine's status is also advantageous. If for instance the quality data are checked with respect to machine speeds or speed changing processes, problematic production speeds can be detected and possibly either avoided or run through especially quickly. As a result, certain production runs can for instance be done at specified maximum machine speeds, if it is found that the quality increases markedly if the machine speed is lowered by a small amount.

Optionally, measuring the color saturation, in addition to the processing position, is also employed, in particular by means of a mark current sensor. The same mark current sensor that also performs the register error measurement for the register regulation is preferably used for ascertaining the color saturation. The mark current sensor is also preferably used downstream of the last printing unit, because it detects all the colors. They can thus be associated directly with a printed product again. Quality assessment of the color saturation can be done individually or in arbitrary combination with the assessment of the lateral or longitudinal register. The measured values can be processed as described above and stored in memory in either compressed or uncompressed form. Optionally, the measured values for color saturation from a plurality of mark current sensors for one or more colors can be used to draw conclusions about the degree of drying and/or the moisture content of the individual printing inks. This information can also be included in the quality standard.

### BRIEF DESCRIPTION OF THE DRAWINGS

The invention will be better understood and further and advantages thereof will become more apparent from the ensuing detailed description of a preferred embodiment taken in conjunction with the drawings, in which:

FIG. 1 schematically shows a processing machine, embodied as a printing press;

FIG. 2 is a detail, with register marks, of a product; and

FIG. 3 shows one possibility for evaluation limits of register errors.

### DESCRIPTION OF THE PREFERRED EMBODIMENT

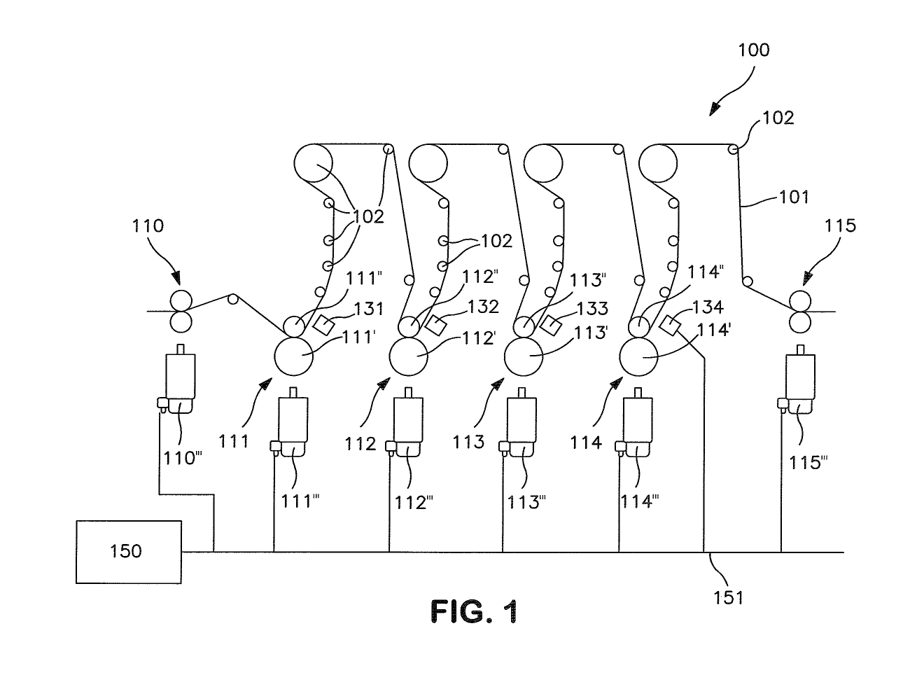

In FIG. 1, a processing machine embodied as a printing press is identified overall by reference numeral 100. A printing material, such as paper 101, is fed to the machine via a drawing-in unit (infeed) 110. The paper 101 is passed through processing devices, embodied as printing units 111, 112, 113, 114, and printed and is output again by a delivery unit (outfeed) 115. The infeeds, outfeeds, and printing units are disposed such that they are positionable, and in particular that they are cylinder- and angle-correctable. The printing units 111-114 can be located in a region between the infeed 110 and the outfeed 115 in which the web tension is regulated. As products, the printing press produces printed images on the paper 101 that are composed of the partial images applied by the printing units 111, 112, 113, 114.

Each of the printing units 111-114 has a respective impression cylinder 111′-114′ against which a respective counterpressure cylinder (counterpressure point) 111″-114″, also known as a pinch or nip roller, is pressed with great pressure. The impression cylinders can be driven individually and independently. The drives 111″′-114″′ belonging to them are shown schematically. The counterpressure cylinders are embodied to be freely rotatable. The printing units 111-114, together with the paper 101 passing through them, form a frictionally connected unit (clamping point). The drives of the individual units are connected to a controller 150 via a data connection 151. In addition, a plurality of detection units 131, 132, 133, 134 for detecting register marks are located between the printing units and are likewise connected to the controller 150. For the sake of simplicity, only the sensor 134 is shown connected to the controller.

In the web portions between the individual printing units 111-114, the paper 101 is guided over rollers, not shown in detail, some of which are identified by reference numeral 102. For the sake of simplicity, not all the rollers are identified by reference numeral 102. These can in particular be deflection rollers, drying, cooling or cutting devices, and so forth.

How a register regulation is performed in the printing press shown will be described below. For printing that stays in register, the partial images printed by the printing units 111-114 must be located in the correct position one above the other. For determining the processing position (printing position) of the partial images, a processing mark (register mark) is imprinted with each partial image. These register marks are detected by the detection units 131, 132, 133, 134 that are embodied as mark readers, or in other words as contrast sensors.

One possibility of characterizing known register methods is to observe the reference variables that are used to ascertain the deviation in position of the partial images from their desired positions. With this capability of differentiation, a distinction can be made between web/web methods and web/cylinder methods.

In a web/cylinder method, as the web of material passes through the press the position of a predetermined register mark and the position of an impression cylinder (ascertained for instance by using a rotary transducer) are compared. In a web/web method, as the web of material passes through the press the position of a predetermined register mark and of a further register mark are compared. In both cases, any deviation in register can be calculated. The register deviations found are used for positioning the printing units-of the measured register mark on the one hand and of the printing unit that has printed the further register mark on the other.

If the predetermined register mark is the mark applied by the preceding impression cylinder, the term used is predecessor color regulation. If the predetermined register mark is always the same register mark (which is preferably applied by the first printing unit), the term used is static color regulation.

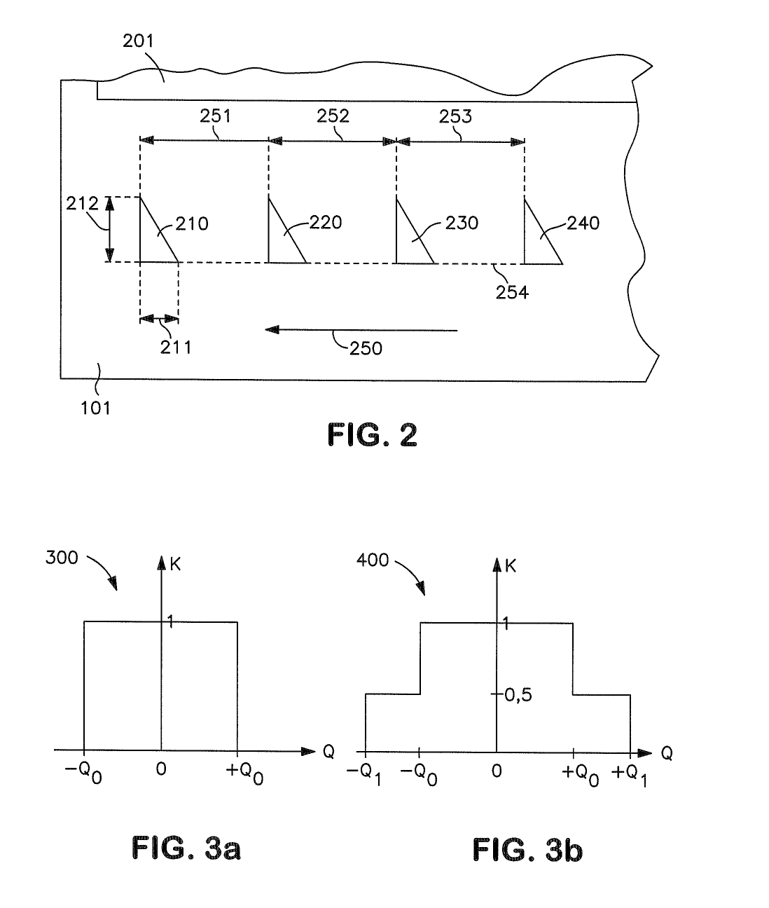

In one embodiment of the invention, the sensor of detection unit 134 is used to detect the longitudinal and lateral register position not only of the printing unit 114, but of all the printing units 111-114. From these measured values, a quality standard is then determined in the controller 150. This will be described in further detail below in conjunction with FIG. 2.

In FIG. 2, a detail of a printed web of paper 101 is shown that contains a number of printed register marks 210, 220, 230, 240. In a printing press, printed images, as products, are made on the material; of these, one is shown schematically and partially and is identified by reference numeral 201. As shown, the reference marks are typically located outside the product. Each of the register marks 210, 220, 230, 240 has been printed by one of the printing units 111-114. As an example, the register mark 210 has been printed by printing unit 111, the register mark 220 by the printing unit 112, the register mark 230 by the printing unit 113, and the register mark 240 by the printing unit 114.

Each of the printed marks is embodied as triangular, for instance, and has a length 211 along the material flow direction 250 as well as a width 212 crosswise to the material flow direction. The register marks 210-240 are moreover disposed relative to one another and have spacings 251, 252, and 253 from one another in the material flow direction 250.

In the described embodiment of the invention, a quality standard for the imprinted product is determined by determining the processing positions of the printing units 111-114 relative to one another. This is done by means of measuring the printed register marks 210-240 printed by the individual printing units 111-114.

Longitudinal register errors can be determined by determining the spacings 251, 252, and 253 among the printed marks and checking them (predecessor color regulation). Lateral register errors can be determined by determining the orientation of the printed register marks 210-240 relative to a straight line 254. In practice, this is done for instance on the assumption that the spacing device in the material flow direction has a very narrow evaluation zone, which uses the length, scanned by the sensor, of the mark. The shorter the length of the mark parallel to 211, the farther the partial image has shifted outward. The longer the length of the mark parallel to 211, the farther the partial image has shifted inward.

As a result, for three or all four printed marks—depending on the chosen strategy—one longitudinal register error and one lateral register error is determined. From the longitudinal and/or lateral register errors determined, a quality standard can for instance be determined, using the maximum value of the register errors ascertained. Based on the quality standard determined, the products can be categorized, as is shown in more detail in FIGS. 3a and 3b.

In FIG. 3a, a first kind of categorization is shown schematically in graph 300. A quality standard Q, for instance the maximum value of a register error, is plotted on an X axis over a rejection criterion K on a Y axis. A threshold value Q₀, in this example symmetrical, is specified and describes the limit for an acceptable product. If the quality standard Q is within the limits −Q₀ +Q₀, the product is assigned the criterion “1” (good); if the quality standard is outside the limits, the product is assigned the criterion “0” (not good).

In FIG. 3b, a second kind of categorization is shown schematically in graph 400. The categorization shown in FIG. 3b allows the assessed products to be subdivided into three groups: “K=1” (good), “K=0.5” (average) and “K=0” (not good). The associated limits of the quality standard are designated Q₀ and Q₁. The axes in graph 400 also correspond to the axes in graph 300.

In FIG. 3, limit values −Q₀, +Q₀, −Q₁, −Q₁ that are symmetrical to 0 are shown. It is understood that comparison limits that are asymmetrical may also be employed.

The foregoing relates to a preferred exemplary embodiment of the invention, it being understood that other variants and embodiments thereof are possible within the spirit and scope of the invention, the latter being defined by the appended claims.

We claim:

1. A method for determining a quality standard for a product processed by a processing machine, in particular a printing press, having at least two printing units, comprising the steps of:
determining processing positions of the at least two printing units relative to one another; and
ascertaining the quality standard based on determined processing positions.

2. The method as defined by claim 1, wherein the processing positions of the at least two printing units relative to one another are determined by means of a detection unit, which is also performs register regulation.

3. The method as defined by claim 1, wherein the processing positions of the at least two printing units relative to one another are determined by means of determining longitudinal and/or lateral register errors.

4. The method as defined by claim 2, wherein the processing positions of the at least two printing units relative to one another are determined by means of determining longitudinal and/or lateral register errors.

5. The method as defined by claim 1, wherein the processing positions of the at least two printing units relative to one another are determined downstream of a last printing unit in a material flow direction.

6. The method as defined by claim 2, wherein the processing positions of the at least two printing units relative to one another are determined downstream of a last printing unit in a material flow direction.

7. The method as defined by claim 3, wherein the processing positions of the at least two printing units relative to one another are determined downstream of a last printing unit in a material flow direction.

8. The method as defined by claim 4, wherein the processing positions of the at least two printing units relative to one another are determined downstream of a last printing unit in a material flow direction.

9. The method as defined by claim 1, wherein the processing positions of the at least two printing units relative to one another are determined by means of precisely one detection unit.

10. The method as defined by claim 8, wherein the processing positions of the at least two printing units relative to one another are determined by means of precisely one detection unit.

11. The method as defined by claim 1, wherein by the at least two printing units, for identifying its own processing position, at least one processing mark each is applied to a material being processed, and the processing positions of the at least two printing units are determined by detecting at least one processing mark each.

12. The method as defined by claim 9, wherein by the at least two printing units, for identifying its own processing position, at least one processing mark each is applied to a material being processed, and the processing positions of the at least two printing units are determined by detecting at least one processing mark each.

13. The method as defined by claim 9, wherein a mark sensor is used as the detection unit.

14. The method as defined by claim 12, wherein a mark sensor is used as the detection unit.

15. The method as defined by claim 1, wherein the quality standard is determined for each processed product.

16. The method as defined by claim 1, wherein the quality standard is stored in memory in compressed or uncompressed form.

17. The method as defined by claim 1, wherein the quality standard is linked to the product.

18. The method as defined by claim 1, wherein a number of quality standards are evaluated.

19. The method as defined by claim 1, wherein the quality standard is determined based on an ascertained color saturation.

20. The method as defined by claim 1, wherein the processing positions of all the printing units relative to one another are determined.
